(19) United States
(12) Patent Application Publication
(10) Pub. No.: US 2025/0286752 A1
(43) Pub. Date: Sep. 11, 2025

(54) OCC/MUI REMOVAL FILTER BASED FREQUENCY DOMAIN CHANNEL ESTIMATION

(71) Applicant: Samsung Electronics Co., Ltd., Suwon-si, Gyeonggi-do (KR)

(72) Inventors: Thuy Van Nguyen, Plano, TX (US); Yang Li, Plano, TX (US); Yeqing Hu, Allen, TX (US)

(21) Appl. No.: 19/047,578

(22) Filed: Feb. 6, 2025

Related U.S. Application Data
(60) Provisional application No. 63/563,257, filed on Mar. 8, 2024.

(51) Int. Cl. H04L 25/02

(52) U.S. Cl. CPC H04L 25/022; H04L 25/0212; H04L 25/0226; H04L 25/0244

(57) ABSTRACT

A method and device for filtering-based channel estimation. A method comprises configuring a filter design with a stopband region between at least two bandpass regions in a time domain associated with channel behavior, suppressing, via the filter design, multi-user interference (MUI) or orthogonal cover code (OCC) interference in the time domain, and providing frequency domain-based channel estimation (CE) based on the filter design.

### CROSS-REFERENCE TO RELATED APPLICATION(S) AND CLAIM OF PRIORITY

This application claims priority under 35 U.S.C. § 119 (e) to U.S. Provisional Patent Application No. 63/563,257 filed on Mar. 8, 2024, which is hereby incorporated by reference in its entirety.

### TECHNICAL FIELD

This disclosure relates to a filtering-based channel estimation process that suppresses multi-user interference (MUI) or orthogonal cover code (OCC) interference.

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

In time division duplex (TDD), a common approach to acquire downlink (DL) channel state information is to exploit uplink (UL) channel estimation through receiving UL reference signals (RSs) (e.g., sounding reference signals (SRS)) sent from a user equipment (UE). By using the channel reciprocity in TDD systems, the UL channel estimation itself can be used to infer DL channels. This favorable feature enables a network (NW) to reduce the training overhead significantly. Thus, in the gNodeB (gNB), channel estimation (CE) is important for achieving high spectral efficiency and reliable cell coverage, as the estimated channel state information (CSI) is used for many operations.

There are two types of channel estimation: SRS-based CE and demodulation reference signal (DMRS) CE. SRS-based CE is implemented in the gNB, which relies on the sounding reference signal (SRS) to estimate the CSI in a TDD system, and uses it to perform scheduling and beamforming weight calculation. DMRS CE is used for UL data reception, where the gNB obtains the CSI via DMRS, and uses it for equalization.

The CE typically includes two stages of operation:
A noisy estimate is obtained by removing the reference signals (RS);
The noisy estimate is refined before it can be used in subsequent modules or processing.

The refinement stage is important, and usually requires carefully designed algorithms. In conventional signal processing, the minimum mean square estimator (MMSE) is optimal in the sense of the mean square error (MSE). The MMSE estimator exploits the second order channel statistics such as the covariance and cross-correlation matrices, and SNR/noise power. However, these statistics are usually difficult to calculate, due to:
The pilots/RS are transmitted sparsely in time and frequency domain;
The RS can display varying SNR due to power control and environment change; and
The channel can experience non-stationarity especially in a mobility scenario.

As a result, the MMSE is computationally expensive to deploy in commercial systems. Thus, good performance and low complexity CE algorithms are important for practical NR systems.

### SUMMARY

Embodiments of the present disclosure provide methods and devices for filtering-based channel estimation that suppresses MUI or OCC interference.

In one embodiment, a method for filtering-based channel estimation comprises configuring a filter design with a stopband region between at least two bandpass regions in a time domain associated with channel behavior, suppressing, via the filter design, multi-user interference (MUI) or orthogonal cover code (OCC) interference in the time domain, and providing frequency domain-based channel estimation (CE) based on the filter design.

In another embodiment, an electronic device comprises a memory, and a processor coupled to the memory. The processor is configured to: configure a filter design with a stopband region between at least two bandpass regions in a time domain associated with channel behavior; suppress, via the filter design, multi-user interference (MUI) or orthogonal cover code (OCC) interference in the time domain; and provide frequency domain-based channel estimation (CE) based on the filter design.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example antenna blocks or arrays according to embodiments of the present disclosure;

FIG. 5 illustrates an example of cyclic shift (CS) sequences for eight UEs that are separated in a delay domain according to embodiments of the present disclosure;

FIG. 6 illustrates an example illustrating a time domain window to remove MUI and denoising according to embodiments of the present disclosure;

FIG. 7 illustrates an example of filter-based channel estimation (CE) for MUI removal and de-noising according to embodiments of the present disclosure;

FIG. 8 illustrates an example of a channel estimation block diagram according to embodiments of the present disclosure;

FIGS. 9A and 9B illustrate an example of filter coefficients in a frequency domain, and filter response in a delay domain according to embodiments of the present disclosure;

FIG. 10 illustrates an example filter based channel estimation procedure according to embodiments of the present disclosure;

FIG. 11 illustrates an example filter based channel estimation system according to embodiments of the present disclosure; and

FIG. 12 illustrates an example process for filtering-based channel estimation that suppresses MUI or OCC interference according to embodiments of the present disclosure.

### DETAILED DESCRIPTION

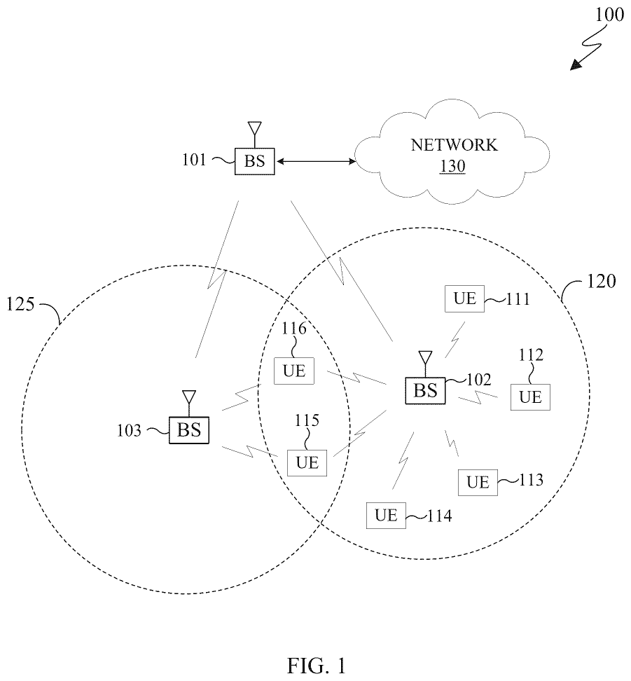

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] 3GPP TS 36.211 v16.4.0, “E-UTRA, Physical channels and modulation”; [2] 3GPP TS 36.212 v16.4.0, “E-UTRA, Multiplexing and Channel coding”; [3] 3GPP TS 36.213 v16.4.0, “E-UTRA, Physical Layer Procedures”; [4] 3GPP TS 36.321 v16.3.0, “E-UTRA, Medium Access Control (MAC) protocol specification”; [5] 3GPP TS 36.331 v16.3.0, “E-UTRA, Radio Resource Control (RRC) Protocol Specification”; [6] 3GPP TS 38.211 v16.4.0, “NR, Physical channels and modulation;” [7] 3GPP TS 38.212 v16.4.0, “NR, Multiplexing and Channel coding”; [8] 3GPP TS 38.213 v16.4.0, “NR, Physical Layer Procedures for Control”; [9] 3GPP TS 38.214 v16.4.0, “NR, Physical Layer Procedures for Data”; [10] 3GPP TS 38.215 v16.4.0, “NR, Physical Layer Measurements”; 3GPP TS 38.321 v16.3.0, “NR, Medium Access Control (MAC) protocol specification”; and 3GPP TS 38.331 v16.3.1, “NR, Radio Resource Control (RRC) Protocol Specification”.

Embodiments of the present disclosure recognize that one problem of channel estimation is how to effectively suppress MUI interference in the CE process. Some MUI removal methods produce residual errors that are difficult to compensate for with advanced signal processing technique. The un-avoided reducible MUI errors substantially degrade the CE performance, i.e., high normalized mean square error (NMSE) error floor CE at the high SNR regime.

Accordingly, various embodiments of the present disclosure can provide methods and apparatuses for filtering-based channel estimation in the frequency domain that suppresses MUI or OCC interference that exploits the knowledge of time domain behavior of the channels. Using filter design theory, the filter-based CE can be designed by putting a wide and deep NULL at interferent UE regions, and by putting a passband region in the target UE region, all in the delay domain. Further, various embodiments of the present disclosure can suppress MUI/OCC interference in a time domain without implementing fast-Fourier-transform (FFT) operation as an equivalent time domain-based CE. In addition, various embodiments of the present disclosure can produce different CE filters that optimize performance in different channel scenarios (tapped delay line (TDL), clustered delay line (CDL), low SNRs, high SNRs, urban microcell (UMI), urban macrocell (UMA), and that can work with simple supervised machine learning algorithms.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

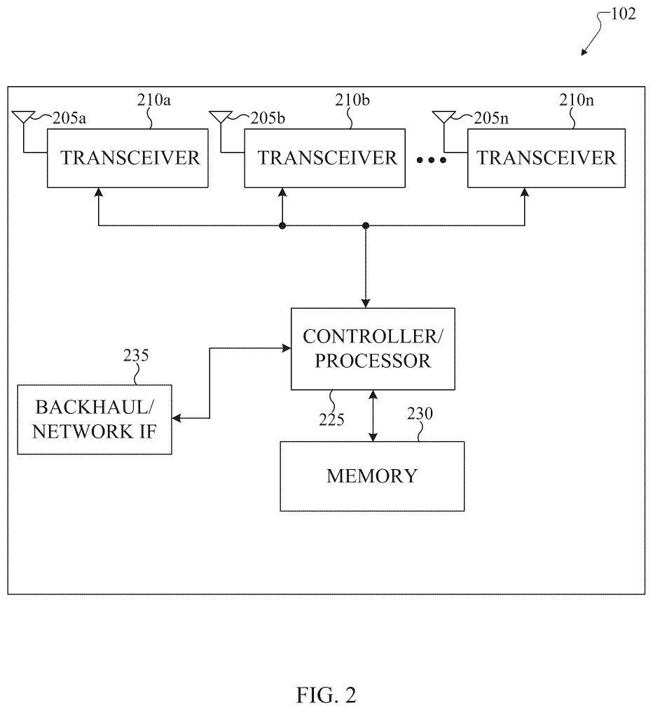

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 or the transceivers 210a-210n may include circuitry and/or programming for facilitating filtering-based channel estimation that suppresses MUI or OCC interference. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

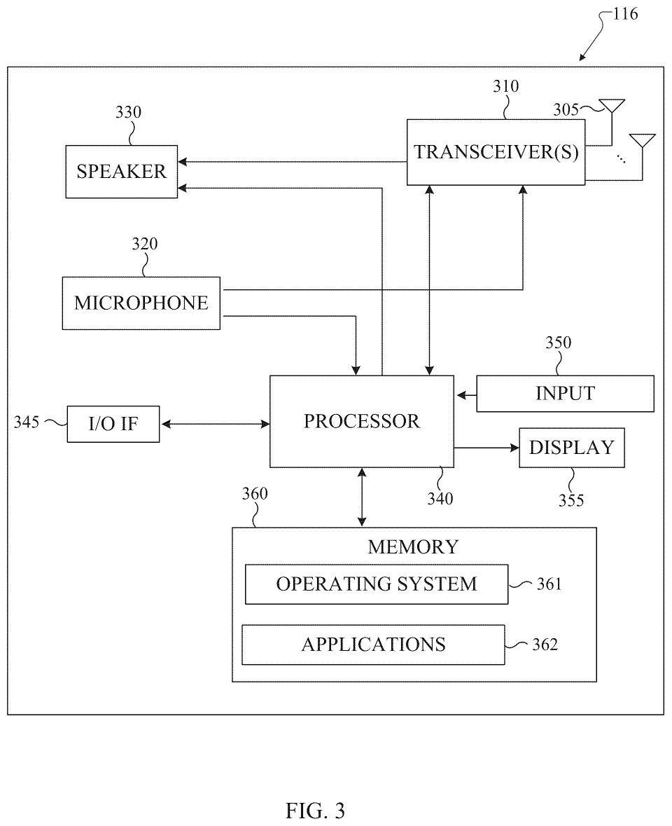

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) and/or baseband signal. The IF and/or baseband signal is processed by RX processing circuitry in the transceiver(s) 310 and/or processor 340, which generates a processed baseband signal by filtering, decoding, and/or digitizing the baseband signal and/or IF signal. The RX processing circuitry sends the processed baseband signal to the speaker 330 (such as for voice data) or is processed by the processor 340 (such as for web browsing data). In some cases, the IF signals and the baseband signal are not equivalent. IF signal can be the intermediate step processing to lower the carrier frequency, then after that it enters demodulation processing to get the baseband signal (e.g., removing IF frequency).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can include circuitry and/or programming for facilitating filtering-based channel estimation that suppresses MUI or OCC interference. The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

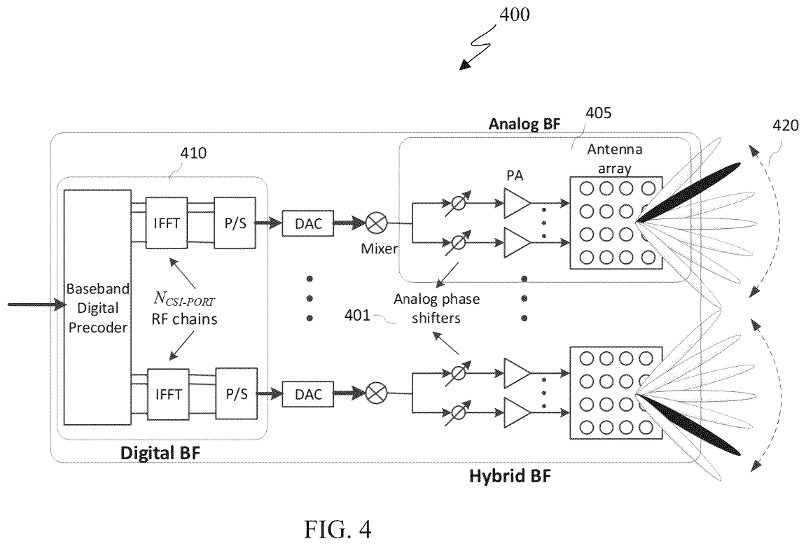

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of this disclosure to any particular implementation of the antenna blocks or arrays.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports-tends to be limited due to hardware constraints (such as the feasibility to install a large number of ADCs/DACs at mmWave frequencies) as illustrated in FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports NCSI-PORT. A digital beamforming unit 410 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

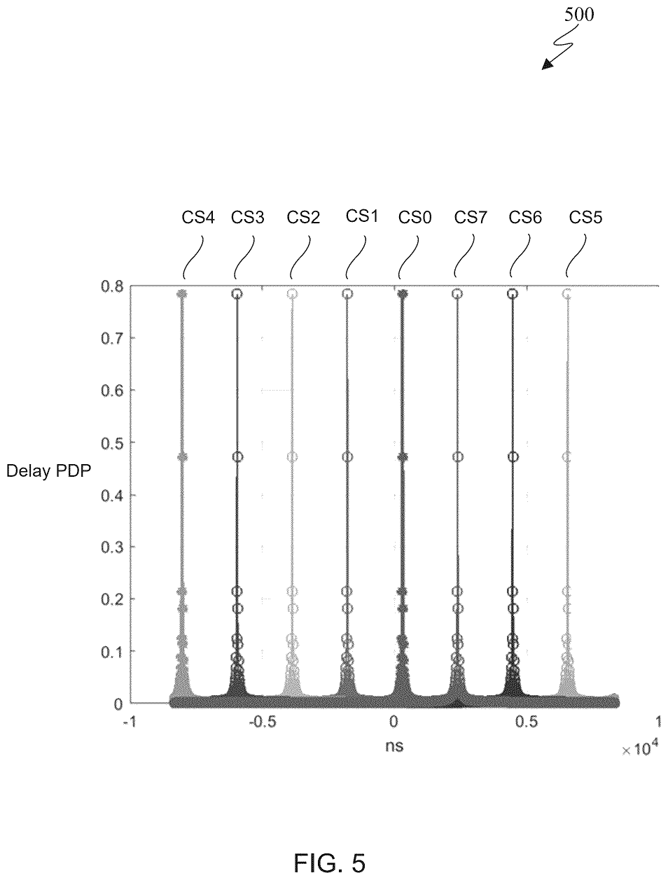

FIG. 5 illustrates an example of cyclic shift (CS) sequences for eight UEs that are separated in a delay domain 500 according to embodiments of the present disclosure. The embodiment of the example of cyclic shift (CS) sequences for eight UEs that are separated in a delay domain 500 illustrated in FIG. 5 is for illustration only. Other embodiments of the example of cyclic shift (CS) sequences for eight UEs that are separated in a delay domain 500 could be used without departing from the scope of this disclosure.

The example illustrated in FIG. 5 is an example of CS-8, which can cover eight UEs at the same time. However, other example CS sequences could also be used. As a non-limiting example, an example of CS-2 can cover two CS sequences: CS0 and CS4 for two UEs.

Embodiments of the present disclosure can be implemented in an orthogonal frequency-division multiplexing (OFDM) system. For an arbitrary user at one snapshot, \hat{x} (m) is the transmitted reference signal (RS) pilot at the m-th subcarrier, and yₖ(m) is the received signal at the corresponding resource, on the k-th gNB antenna element. The first step of channel estimation is to apply the least square (LS) algorithm to remove the RS, and obtain the initial noisy estimate as

$${\hat{h}}_{k} ( m ) = {y}_{k} ( m ) / \hat{x} ( m ) \qquad ( 1 )$$

Multiple users can be multiplexed on the same time-frequency resource by the Zadoff-Chu (ZC) sequence and cyclic shift (CS), hence yₖ(m) contains other user's channel information, in addition to being impaired by varying noise. Therefore, the estimated channel ĥₓ(m) should be further refined before it can be applied for transmission or reception. For a single snapshot of the channel, the goal is to obtain a refined channel estimate \hat{ĥ}ₖ(m) as close as possible to the ground truth channel hₖ(m).

The channel model is given as

$$y ( n ) = {h}_{1} ( n ) {e}^{j {α}_{1} n} + … + {h}_{K} ( n ) {e}^{j {α}_{k} n} \qquad ( 2 )$$

where hᵢ(n) is a channel of user i, i=1, . . . , K. In SRS modelling, each UE is separated by orthogonal cyclic sequence (CS) αᵢ. The orthogonality visualization of different CS sequences is illustrated in FIG. 5.

To remove the MUI, one example method is to use a matrix inversion of an equivalent CS matrix as:

First, normalize by the 1^{st} CS:

$${y}^{′} ( n ) = y ( n ) / {e}^{j {α}_{1} n} \qquad ( 3 )$$

$$→︀ {y}^{′} ( n ) = {h}_{1} ( n ) + … + {h}_{K} ( n ) {e}^{j ( {α}_{k} - {α}_{1} ) n}$$

Then remove MUI:

$${y}^{′} ( n ) = {h}_{1} ( n ) + … + {h}_{k} ( n ) {e}^{j ( {α}_{k} - {α}_{1} ) n} + {h}_{K} ( n ) {e}^{j ( {α}_{K} - {α}_{1} ) n} \qquad ( 4 )$$

$${y}^{′} ( n + 1 ) = {h}_{1} ( n ) + … + {h}_{k} ( n ) {e}^{j ( {α}_{k} - {α}_{1} ) ( n + 1 )} + {h}_{K} ( n ) {e}^{j ( {α}_{K} - {α}_{1} ) ( n + 1 )}$$

$$…$$

$${y}^{′} ( n + K - 1 ) = {h}_{1} ( n ) + … + {h}_{k} ( n ) {e}^{j ( {α}_{k} - {α}_{1} ) ( n + K - 1 )} + {h}_{K} ( n ) {e}^{j ( {α}_{K} - {α}_{1} ) ( n + K - 1 )}$$

$$→︀ [ \begin{matrix}{h\_est}_{1} ( n ) \\ ⋮ \\ {h\_est}_{k} ( n ) \\ ⋮ \\ {h\_est}_{K} ( n )\end{matrix} ] = {[ \begin{matrix}1 … {e}^{j ( {α}_{k} - {α}_{1} ) n} … {e}^{j ( {α}_{K} - {α}_{1} ) n} \\ ⋱ \\ 1 … {e}^{j ( {α}_{k} - {α}_{1} ) ( n + 1 )} … {e}^{j ( {α}_{K} - {α}_{1} ) ( n + 1 )} \\ ⋱ \\ 1 … {e}^{j ( {α}_{k} - {α}_{1} ) ( n + K )} … {e}^{j ( {α}_{K} - {α}_{1} ) ( n + K )}\end{matrix} ]}^{- 1} [ \begin{matrix}{y}^{′} ( n ) \\ ⋮ \\ {y}^{′} ( n + k - 1 ) \\ ⋮ \\ {y}^{′} ( n + K - 1 )\end{matrix} ]$$

Some embodiments of the present disclosure recognize that there are two main CE solutions to remove MUI interference: in the frequency domain and in the time domain. In the frequency domain, MUI removal is implemented by using a small NULL at the interference location (by implementing an inversion matrix as in equation (4) above). One drawback of this approach is a high residual error floor at a high SNR regime. In the time domain, MUI removal is separated using a fixed window, and since the channel energy is concentrated within a portion of the time domain region, an interference region can be separated using a simple widowing method. However, this method requires a fast Fourier transform (FFT) operation, which might add more complexity in the CE algorithm.

Various embodiments of the present disclosure provides a CE method (similar to a moving average method) in the frequency domain, that exploits the knowledge of time domain behavior of the channels.

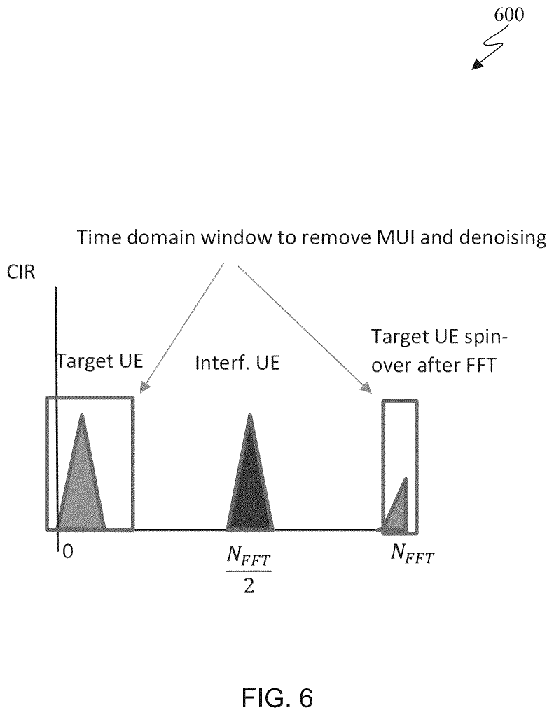

FIG. 6 illustrates an example illustrating a time domain window to remove MUI and denoising 600 according to embodiments of the present disclosure. The embodiment of the example illustrating a time domain window to remove MUI and denoising 600 illustrated in FIG. 6 is for illustration only. Other embodiments of the example illustrating a time domain window to remove MUI and denoising 600 could be used without departing from the scope of this disclosure.

As illustrated in FIG. 6, which uses one time/delay domain processing approach, a rectangular window is applied in the time domain for MUI removal and denoising. This rectangular windowing in the time domain is equivalent to the convolution equivalent operation in the frequency domain, where the equivalent TD rectangular window is in a sinc function in the frequency domain with filter length N_FFT. If this sinc function is applied (to get equivalent time domain effects for MUI removal and denoising), there are two disadvantages:
The filter length is too large, leading to high complexity.
The filter coefficients are complex.

The present disclosure addresses these disadvantages by providing a filter-based CE approach that exploits time domain knowledge but does not require that an FFT operation be performed as in time domain processing.

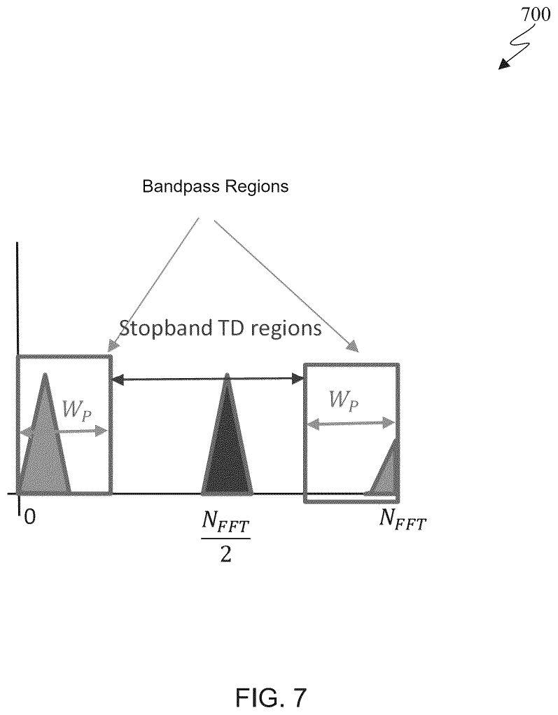

FIG. 7 illustrates an example of filter-based channel estimation (CE) for MUI removal and de-noising 700 according to embodiments of the present disclosure. The embodiment of the example of filter-based channel estimation (CE) for MUI removal and de-noising 700 is for illustration only. Other embodiments of the example of filter-based channel estimation (CE) for MUI removal and de-noising 700 could be used without departing from the scope of this disclosure.

With the system design knowledge and after channel time compensation processing, it can be assumed that the target UE channels in the delay domain concentrate within a cyclic prefix (CP) length. Thereafter, a filter is provided in accordance with the illustration in FIG. 7 where:
TD Passband region: W_{P}≤CP.
The whole TD region (0 . . . . N_{FFT}) is equivalent to [0 . . . 2π] where the regions around {0, N_{FFT}} are associated with low frequency regions and the region around

$$\frac{{N}_{F F T}}{2}$$

is associated with a high frequency region.

In some embodiments, the filter design may be directed only to the target UE channel, or equivalently a delay domain low-pass filter may be designed, with bandpass W_{P}; and a NULL may be placed at the stopband (i.e., interf. UE region).

When the filter design is symmetric in the delay domain, that will result in real symmetric filter coefficients in the frequency domain, which will provide low complexity implementation.

With the design filter framework, the performance trade-off between filter length and the transition slope of the filter and ripple attenuation in the stopband region can be studied. Since the channel is sparse, the filter transition slope will not affect the CE normalized mean square error (NMSE) performance significantly.

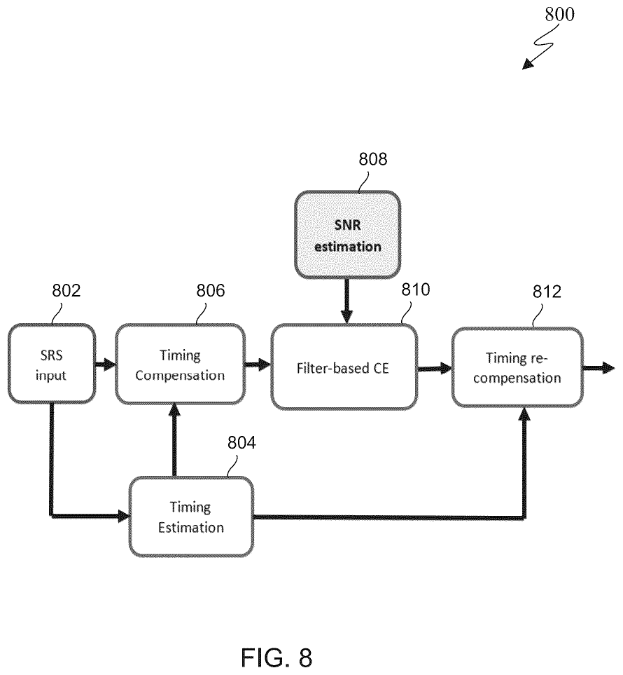

FIG. 8 illustrates an example of a channel estimation block diagram 800 according to embodiments of the present disclosure. The embodiment of the example of a channel estimation block diagram 800 is for illustration only. Other embodiments of the example of a channel estimation block diagram 800 could be used without departing from the scope of this disclosure.

As illustrated in FIG. 8, a time offset 804 is estimated from noisy sounding reference signal (SRS) channels 802. Thereafter, the channels are time compensated 806, and filter-based CE 810 based on the time compensated channels 806 and signal-to-noise ratio (SNR) estimation 808 is performed. Thereafter, the estimated channels are re-time compensated 812 to return the actual channel time offsets.

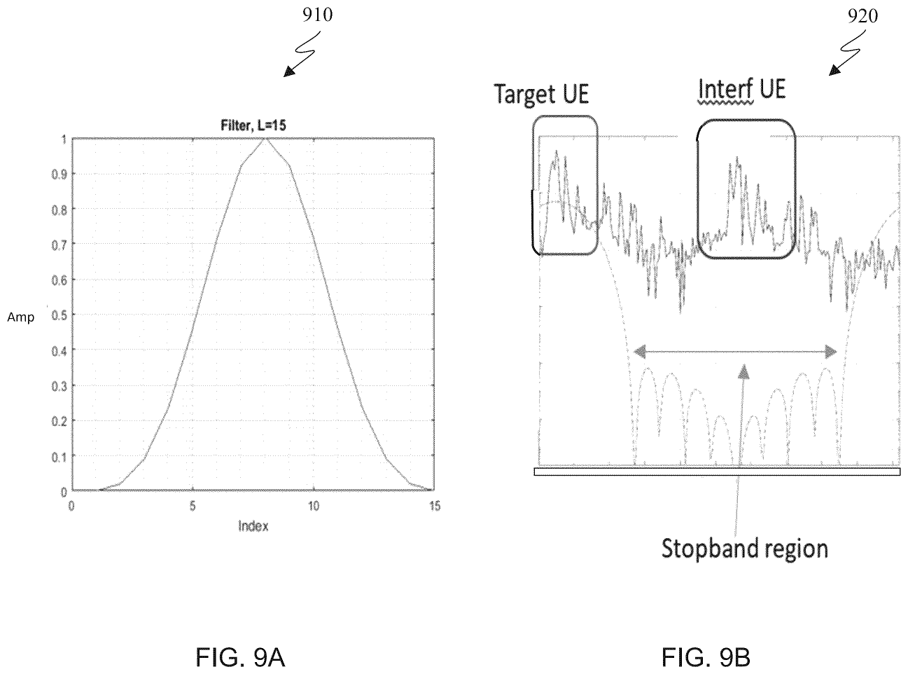

FIGS. 9A and 9B illustrate an example of filter coefficients of a design filter in a frequency domain 910, and the design filter's response in a delay domain 920 according to embodiments of the present disclosure. The embodiment of the example of filter coefficients of a design filter in a frequency domain 910, and the design filter's response in a delay domain 920 is for illustration only. Other embodiments of the example of filter coefficients of a design filter in a frequency domain 910, and the design filter's response in a delay domain 920 could be used without departing from the scope of this disclosure.

The illustrations in FIGS. 9A and 9B are based on a filter that has been designed in accordance with the filter-based CE procedure and having a filter with length L=15. As illustrated in FIGS. 9A and 9B, it can be seen that the designed filter has a deep and wide NULL at the interference UE region that will help to improve the CE performance significantly.

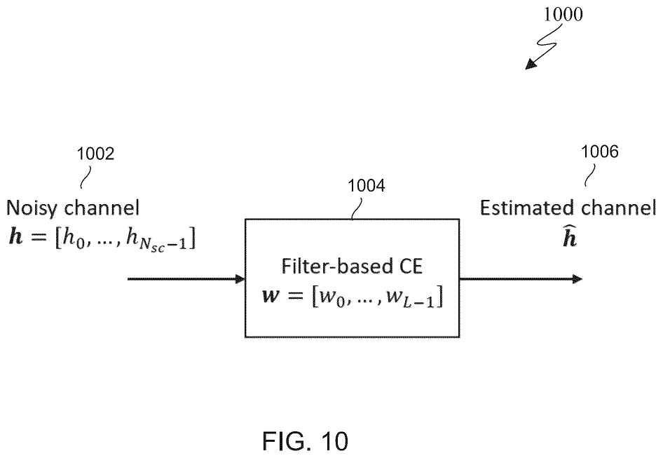

FIG. 10 illustrates an example filter based channel estimation procedure 1000 according to embodiments of the present disclosure. The embodiment of the example filter based channel estimation procedure 1000 is for illustration only. Other embodiments of the example filter based channel estimation procedure 1000 could be used without departing from the scope of this disclosure.

As illustrated in FIG. 10, a noisy channel 1002 is input to the filter-based CE 1004, producing an estimated channel 1006. The filter-based CE procedure is similar to other windowing filtering operations as follows:

$${\hat{h}}_{k} = \{ \begin{matrix}{\sum }_{i = ⌊ \frac{L}{2} ⌋ - k + 1}^{\frac{L}{2} + k + 1} {h}_{k - ⌊ \frac{L}{2} ⌋ + i} * {w}_{i} , k \leq ⌊ \frac{L}{2} ⌋ \\ {\sum }_{i = 0}^{L - 1} {h}_{k - ⌊ \frac{L}{2} ⌋ + i} * {w}_{i} , k = [ ⌊ \frac{L}{2} ⌋ + 1 , … , {N}_{sc} - ⌊ \frac{L}{2} ⌋ ] \\ {\sum }_{i = ⌊ \frac{L}{2} ⌋ - {N}_{sc} + k )}^{\frac{L}{2} + {N}_{sc} - k} {h}_{k - ⌊ \frac{L}{2} ⌋ + i} * {w}_{i} , k > {N}_{sc} - ⌊ \frac{L}{2} ⌋\end{matrix} \qquad ( 5 )$$

Performance of filter-based CE depends, among other things, on the channel profiles, SNR levels and filter lengths. Thus, online classifications can be applied to choose the best filter (filter type, filter length) for CE algorithms depending on channel profiles, SNRs, etc.

The filter design jointly performs the interference removal and the channel estimation. The objective is to suppress the interference, suppress the noise, while retaining the target channel's signal at the same time, in which the optimal channel estimation may be achieved by minimum mean square error (MMSE) estimation, with estimation weight

$$w = {R}_{h \hat{h}} / {R}_{\hat{h} \hat{h}} \qquad ( 6 )$$

In the delay domain, it can be viewed as interference and/or noise suppression, depending on the interference and noise level considered in Run With stronger MUI present, the sidelobe of the filter is suppressed further. However, MMSE may not be practical since it requires the knowledge of second order statistics of the channel.

In some embodiments, a set of filters can be built, and a codebook can be formed with those filters. In the codebook design of the estimation weight, a similar philosophy can be adopted. Different codewords can be designed to estimate various combinations of:
Target channel delay profile,
Noise level,
Interference level (with respect to the target UE), and/or
Timing offset.

In some embodiments, the noise and interference level can determine the suppression level of the sidelobe, and the timing offset can determine the location of the nulls. Further, in an online classification, the above information can be estimated/classified, mapped to a codeword, and applied for estimation.

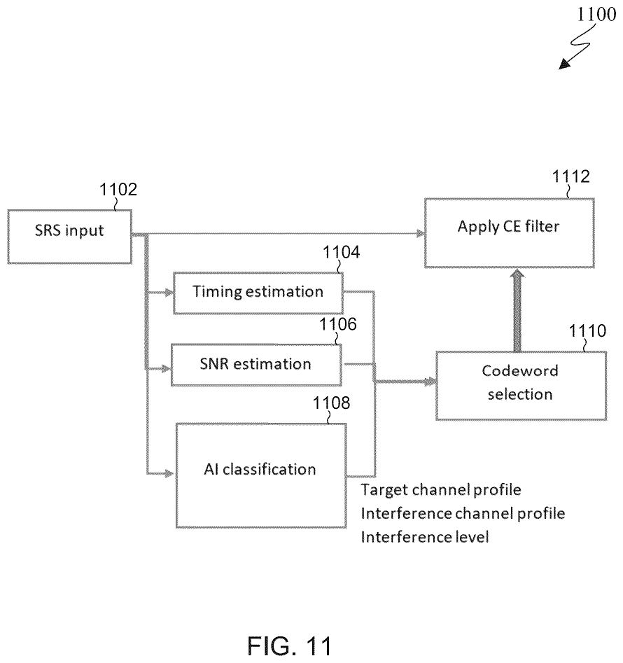

FIG. 11 illustrates an example filter based channel estimation system 1100 according to embodiments of the present disclosure. The embodiment of the example filter based channel estimation system 1100 is for illustration only. Other embodiments of the example filter based channel estimation system 1100 could be used without departing from the scope of this disclosure.

As illustrated in FIG. 11, a timing offset 1104 of the target and interfering UE channels and the SNR 1106 is estimated from received SRS reference channels 1102. An artificial intelligence (AI) model 1108, such as a decision tree, a random forest, or a threshold based method, may be used to choose which filter (or codeword) is best suited for a current channel condition. A codeword database 1110 may store a list of predesigned filters or codewords to choose from, and the CE filter may be applied 1112 based on the codeword database.

In some embodiments, the filter-based CE procedure are in the following steps:
From received SRS or DMRS reference channels, the timing/frequency offset of the target and interfering UE channels, and the SNR is estimated.
From the system design (based on OCC/CS sequence), determine the approximate locations of the interference UEs in the delay domain.
Based on the target UE, cyclic shift the target UE to be near 0 (or low delay bin regions) by timing compensation.
Based on the location of the UE (based on cyclic prefix equivalent delay bin), apply the filter design in the delay equivalent domain, with the constraint filter length (in the frequency domain).
Apply the filter in frequency domain to get the channel estimation.

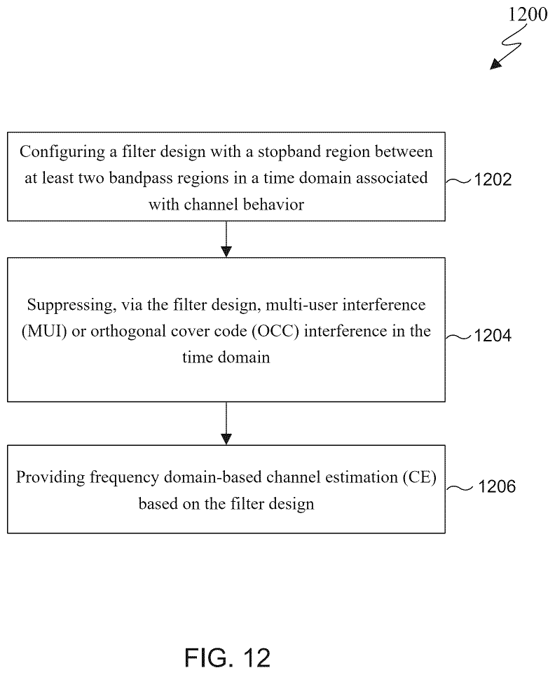

FIG. 12 illustrates an example method 1200 for filtering-based channel estimation according to embodiments of the present disclosure. The embodiment of a method 1200 for filtering-based channel estimation shown in FIG. 12 is for illustration only. Other embodiments of a method 1200 for filtering-based channel estimation could be used without departing from the scope of this disclosure.

As illustrated in FIG. 12, the method 1200 begins at step 1202, and includes configuring a filter design with a stopband region between at least two bandpass regions in a time domain associated with channel behavior. At step 1204, the method includes suppressing, via the filter design, multi-user interference (MUI) or orthogonal cover code (OCC) interference in the time domain. At step 1206, the method includes providing frequency domain-based channel estimation (CE) based on the filter design.

In one embodiment, the method includes suppressing the MUI or OCC interference in the time domain without implementing a fast Fourier transform (FFT) operation.

In one embodiment, the method includes, based on received reference channels, estimating a timing offset of a channel of a target user equipment (UE) and a timing offset of a channel of an interference UE; determining a location of the interference UE in a delay domain and a location of the target UE in the delay domain; and time compensating the channel of the target UE.

In one embodiment, the method includes, based on the location of the target UE, applying a filter in a frequency domain to obtain the frequency domain-based CE.

In one embodiment, the method includes suppressing the MUI or OCC interference in the time domain by providing a finite impulse response (FIR) filter to suppress the MUI or OCC interference.

In one embodiment, the FIR filter comprises one or more of a Blackman filter, a Hann filter, or a Hamming filter.

In one embodiment, the method includes selecting a rectangular window for the filter design.

In one embodiment, the method includes selecting, based on an artificial intelligence (AI) model, a filter or codeword for one or more current channel conditions.

In one embodiment, the AI model comprises a decision tree model or a random forest model.

In one embodiment, the method includes selecting the filter or codeword from a list of filters or codewords in a codeword database.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
configuring a filter design with a stopband region between at least two bandpass regions in a time domain associated with channel behavior;
suppressing, via the filter design, multi-user interference (MUI) or orthogonal cover code (OCC) interference in the time domain; and
providing frequency domain-based channel estimation (CE) based on the filter design.

2. The method of claim 1, further comprising suppressing the MUI or OCC interference in the time domain without implementing a fast Fourier transform (FFT) operation.

3. The method of claim 1, further comprising:
based on received reference channels, estimating a timing offset of a channel of a target user equipment (UE) and a timing offset of a channel of an interference UE;
determining a location of the interference UE in a delay domain and a location of the target UE in the delay domain; and
time compensating the channel of the target UE.

4. The method of claim 3, further comprising:
based on the location of the target UE, applying a filter in a frequency domain to obtain the frequency domain-based CE.

5. The method of claim 1, further comprising suppressing the MUI or OCC interference in the time domain by providing a finite impulse response (FIR) filter to suppress the MUI or OCC interference.

6. The method of claim 5, wherein the FIR filter comprises one or more of a Blackman filter, a Hann filter, or a Hamming filter.

7. The method of claim 6, further comprising selecting a rectangular window for the filter design.

8. The method of claim 1, further comprising:
selecting, based on an artificial intelligence (AI) model, a filter or codeword for one or more current channel conditions.

9. The method of claim 8, wherein the AI model comprises a decision tree model or a random forest model.

10. The method of claim 8, further comprising selecting the filter or codeword from a list of filters or codewords in a codeword database.

11. An electronic device comprising:
a memory; and
a processor coupled to the memory, the processor configured to:
configure a filter design with a stopband region between at least two bandpass regions in a time domain associated with channel behavior;
suppress, via the filter design, multi-user interference (MUI) or orthogonal cover code (OCC) interference in the time domain; and
provide frequency domain-based channel estimation (CE) based on the filter design.

12. The electronic device of claim 11, wherein the processor is further configured to suppress the MUI or OCC interference in the time domain without implementing a fast Fourier transform (FFT) operation.

13. The electronic device of claim 11, wherein the processor is further configured to:
based on received reference channels, estimate a timing offset of a channel of a target user equipment (UE) and a timing offset of a channel of an interference UE;
determine a location of the interference UE in a delay domain and a location of the target UE in the delay domain; and
time compensate the channel of the target UE.

14. The electronic device of claim 13, wherein the processor is further configured, based on the location of the target UE, to apply a filter in a frequency domain to obtain the frequency domain-based CE.

15. The electronic device of claim 11, wherein the processor is further configured to suppress the MUI or OCC interference in the time domain based on a finite impulse response (FIR) filter to suppress the MUI or OCC interference.

16. The electronic device of claim 15, wherein the FIR filter comprises one or more of a Blackman filter, a Hann filter, or a Hamming filter.

17. The electronic device of claim 16, wherein the processor is further configured to select a rectangular window for the filter design.

18. The electronic device of claim 11, wherein the processor is further configured to select, based on an artificial intelligence (AI) model, a filter or codeword for one or more current channel conditions.

19. The electronic device of claim 18, wherein the AI model comprises a decision tree model or a random forest model.

20. The electronic device of claim 18, wherein the processor is further configured to select the filter or codeword from a list of filters or codewords in a codeword database.
